(19) United States
(12) Patent Application Publication
(10) Pub. No.: US 2026/0102720 A1
(43) Pub. Date: Apr. 16, 2026

(54) INCREASED FLOW SCREEN PANEL

(71) Applicants: Christopher S. Keever, Peachtree City, GA (US); Jared Holindrake, Cottonwood Heights, UT (US)

(72) Inventors: Christopher S. Keever, Peachtree City, GA (US); Jared Holindrake, Cottonwood Heights, UT (US)

(21) Appl. No.: 19/355,654

(22) Filed: Oct. 10, 2025

Related U.S. Application Data
(60) Provisional application No. 63/706,286, filed on Oct. 11, 2024.
(60) Provisional application No. 63/816,651, filed on Jun. 3, 2025.
(60) Provisional application No. 63/842,563, filed on Jul. 11, 2025.

(51) Int. Cl. B01D 29/01; B33Y 80/00

(52) U.S. Cl. CPC B01D 29/016; B01D 29/012; B33Y 80/00

(57) ABSTRACT

Disclosed is an increased flow screen panel that has pathways or ridges, which debris can flow up against and be rejected by the screen panel, and flow can still pass around debris and into the orifices.

### CROSS REFERENCE TO RELATED APPLICATION

This application claims priority to U.S. Provisional Application No. 63/706,283 filed Oct. 11, 2024, U.S. Provisional Application No. 63/816,651 filed Jun. 03 2025, and U.S. Provisional Application No. 63/842,563 filed Jul. 11, 2025 all of which are incorporated herein by reference in their entirety.

### BACKGROUND OF THE INVENTION

Screening wastewater is a very important step in the wastewater treatment process. Particulate debris within the wastewater flow is separated from the liquid flow through various types of screens. Some are bar screens, where spaced bars that block the flow trap and reject debris over a certain size on the front side of the screen. Other screens incorporate wedge wire, and yet, others utilize perforated plates. In perforated plate screens, the holes pass the water through and the diameter or size of the openings factor into the level of screening that is accomplished. For example, a ¼ perforated plate screen has a notable impact on rejecting material over ¼ is size.

In sizing a screen properly to accomplish a desired level of debris removal, factors such as peak hydraulic flow, debris loading, wetted screening area, and channel dimensions are important. Screens are designed to pass a required amount of flow based on a portion of the available screening area being blocked. The screen and wetted screening area needs to be large enough to pass the peak hydraulic flow when a notable percentage of the screen is blocked with debris from the water stream. Screens are blocked with debris when material covers the influent holes preventing flow from passing through it. As holes become blocked, there is headloss through the screen increases as less open area is available. Velocities through the remaining holes increase. The holes in the screen are then cleaned through a number of methods, in order to keep the upstream water level from getting too high and surpassing the limits of the influent civil works. It is therefore beneficial to keep as much of the screen area as possible available to pass water and not be blocked with debris.

### BRIEF SUMMARY OF THE INVENTION

The methods and apparatuses disclosed create new pathways for water to travel into and through a screen orifice. Instead of there being one “entry point” for water to enter a hole, a fluid can also pass into the orifice from the side (horizontally, diagonally, or perpendicularly). For example, the influent side of the orifice has individual ridges raised above the orifice opening with spacing between the ridges, allowing water to pass horizontally into the orifice if debris happens to be in front of the orifice. Alternatively, instead of ridges, grooves or pathways can be formed or cut into the sidewall at the orifice opening between adjacent orifices, so that it can pass water from one orifice to the next. The effect of these pathways or ridges is that debris can flow up against the screening panel, and although it is being rejected by the screen panel, flow can still pass around the debris and into the orifices. This is very important as allowing flow to pass through the orifices while still rejecting debris keeps headloss to a minimum and, ultimately, greater capacity in the screening system. It is estimated that up to 50% greater flow rates can be achieved with this novel screen orifice design.

In a nutshell, disclosed is a screen panel where the inlet side of the screen orifices or panel incorporates a feature to elevate (emboss) or drop a portion (deboss) of the inlet side of the orifice. So instead of the face of a screen panel being flat, where the holes or openings of the panel are all on the same plane, the inlet side of the panel incorporates ridges or drops in elevation around an orifice and can also be incorporated into the orifice's inlet.

This design allows for a layered screening system where there is first, a top (or initial) level of screening that occurs between the intermittent ridges on the panel. Then further screening when the water enters the orifice itself. Because the ridges are intermittent around the orifices, there are open pathways between the ridges, between the orifices, and into the orifices. Consequently, if debris, such as a candy wrapper, flows onto the screen panel and rests against the screen panel, it is actually suspended up over the actual orifices on the intermittent ridges. The network of pathways between and below the ridges potentially allow water to pass under the debris and into the orifices. Therefore, this screening panel does not get blinded by debris like other screening panels and does not incur the headloss that other screening panels incur. This translates to much better screenings capture, smaller equipment, reduced costs, and simpler operation and maintenance.

In a preferred embodiment, a screen panel has an influent side with an influent face plate and an effluent side with an effluent face plate. The influent face plate has reliefs with orifice openings spaced between the reliefs. The reliefs can be ridges or shapes raised above the orifice openings, or the reliefs can be grooves or pathways recessed into sidewalls at orifice openings between different orifices. Of course, the orifice openings can be round holes or other geometrical shapes. These reliefs allow water to pass between multiple orifices or rows and even to pass water into the orifice opening when debris is in front of the orifice openings.

In another embodiment, the orifice opening on the influent plate has a gradual slope angled into the orifice opening. Typically, the depth of orifice openings are greater than the orifice openings area.

In other embodiments, the effluent side has a larger orifice opening that tapers to a smaller orifice opening on the influent side. The larger orifice opening on the effluent plate can also have an effluent side gradual slope angled into the larger orifice opening. When an inlet edge of an orifice is rounded or sloped, the drag on a fluid is significantly reduced. Likewise, when the reliefs are rounded or sloped, there is also a significant decrease drag on the fluid.

These screen panels are typically constructed by using additive manufacturing including three-dimensional printing, injecting molding, or any other process that achieves the desired water flow. Using the additive manufacturing process, the screening panel can even be molded within or attached to another system. Further, the screen panel or parts of the screen panel can be molded into a curved panel or the screen panel is manufactured into various shapes and formed in materials that are flexible.

In another embodiment, multiple orifices or ridges of differing size are incorporated into the same panel. The influent face of the panel incorporates shelves or shapes that enhance adhesion and capture of debris.

In yet another embodiment, a screen panel has an effluent side and an influent side with an influent face plate with rows of influent holes at different elevations from the influent face plate. The row of influent holes are oriented vertically, diagonally, or horizontally from a top side. The rows of influent holes at different elevations create steps that are at differing angles from the influent face plate into the influent holes. The rows of influent holes at different elevations create steps that lift debris enabling a flow to pass behind or under the debris to available influent holes in the screen panel. An elevated orifice or reliefs reject larger debris, and recessed reliefs or orifices reject smaller debris. Further, effluent side holes on an effluent side plate can have a gradual slope angled into the effluent side holes to reduce drag.

### BRIEF DESCRIPTION OF THE DRAWINGS

Various embodiments are illustrated by way of examples in the figures of the accompanying drawings. Such embodiments are demonstrative and not intended to be exhaustive or exclusive embodiments of the present subject matter. The drawings are not necessarily to scale, emphasis instead being placed on illustrating the principals of the invention.

FIG. 1 depicts a flat face screen panel typical in the prior art.

FIG. 2 depicts an increased flow panel with ridges.

FIG. 3 depicts an increased flow panel with debossed grooves.

FIG. 4 depicts an orifice with a larger opening sloping to a smaller opening.

FIG. 5 depicts an orifice with rounded orifice openings.

FIG. 6 depicts an increased flow panel with ridges and grooves.

FIG. 7 depicts an increased flow panel with ridges and multidirectional channels.

FIG. 8 depicts an increased flow panel with raised bars.

FIG. 9 depicts a screening panel molded into a pipe created as a single unit.

### DETAILED DESCRIPTION OF THE INVENTION

The description that follows includes compositions, systems, methods, and apparatuses that embody various elements of the present disclosure. However, it should be understood that the described disclosure may be practiced in a variety of forms in addition to those described herein. Accordingly, the referenced drawings show, by way of illustration, specific embodiments in which the invention may be practiced. It is to be understood that other embodiments may be utilized, and structural changes may be made without departing from the scope of the claims. It is further understood that the steps described with respect to the disclosed processes may be performed in differing order and are not limited to the steps presented herein. Accordingly, other implementations describing object sizing, processes, elements, parts or mechanisms can be used and still be within the scope of the claimed invention.

In the preferred embodiments described herein, an increased flow screen panel has pathways or ridges, which debris can flow up against and be rejected by the screen panel, and flow can still pass around debris and into the orifices.

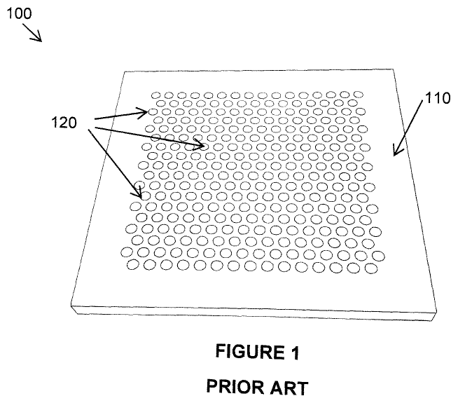

Referring to FIG. 1, illustrated is a flat face screen panel 100 typical in the prior art. The screen 100 has an influent side face 110 with orifices 120. The influent side face 110 as shown has a flat face such that when debris is blocked by the screen 100, the debris generally blocks the flow into the orifices 120 that are now covered and no longer available to transmit water threw the filter 100. This blockage increases headloss and results in increased velocities through the remaining holes 120.

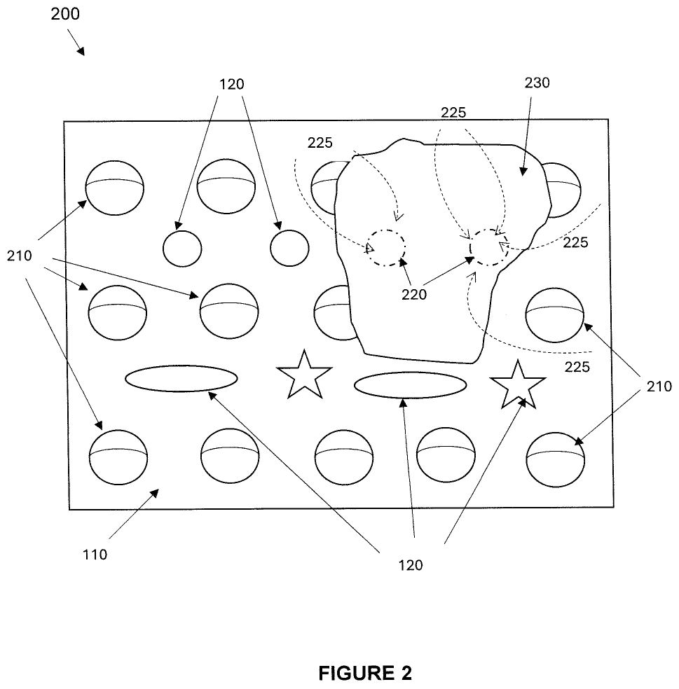

Referring to FIG. 2, illustrated is an embossed flow panel 200 with ridges 210 and orifices 120.. The embossed panel's influent face 110 has reliefs comprising numerous ridges 210. These ridges 210 may be of any shape of size, or number. The ridges 210 catch debris 230 and prevent the debris 230 from blocking access for the fluid to flow into the potentially blocked orifices 220 directly below the debris 230. The ridges 210 allow fluid to flow via channels 225 under the debris 230 into the available orifices 220 that may otherwise be partially or wholly blocked. These ridges 210 thus create new pathways 325 for water to travel into and through a screen orifice 120. Instead of there being one “entry point” for water to enter a hole 120, water can pass straight into the orifice 120 and it can also pass into the orifice from the side (horizontally, diagonally, or perpendicularly). The orifices 120 can be many shapes and sizes. Round holes, slots, stars, and all geometrical shapes may be used. Naturally, various shaped orifices 120 may be used together within the panel 200 as shown. Obviously, the orifice 120 can traverse straight through the panel or be at an angle through the panel.

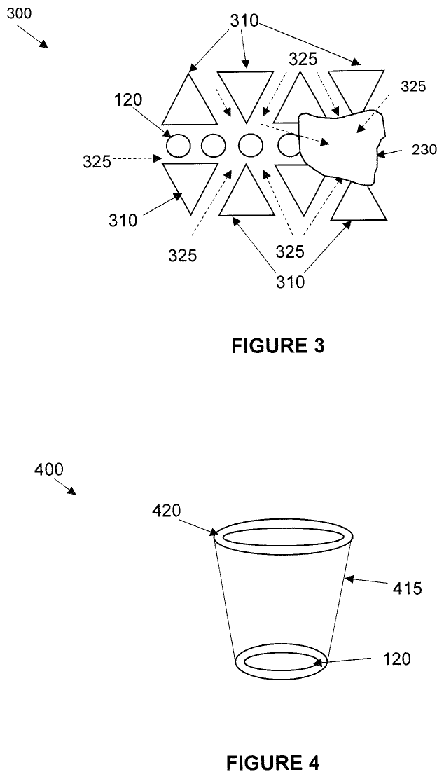

Referring to FIG. 3, illustrated is an debossed flow panel face 300 with channels 325 and orifices 120. Alternatively, instead of ridges, grooves or pathways 325 can be formed or cut into the sidewall at the orifice openings between adjacent orifices 120, so water can pass water from one orifice 120 to the next. The debossed panel's influent face 110 has reliefs comprising numerous channels 325 cut into the flat face 110 resulting in the face having the appearance of numerous triangles 310 with recessed orifices 120 at the bottom of the channels 325. The creation of the channels 325 enables water to flow in the recessed channels 325 and easily access the orifices 120. The effect of these pathways or channels 325 is that debris 230 can flow up against the screening panel 300, and although debris 230 is being rejected by the screen panel 300, flow can still pass under the debris 230 and into the orifices 120.

Referring to FIG. 4, illustrated is an orifice 120 in the influent side of a screen panel 110 that has a smaller area than the area of the effluent side hole 420. The larger orifice opening on the effluent plate can also have an effluent side gradual slope angled into the larger orifice opening. Typically, the depth of orifice openings are greater than the orifice openings area. Smaller openings 120 on the influent side capture debris and particles effectively, while the larger openings 420 on the effluent side allow trapped particles to be more easily dislodged during cleaning (e.g., backwashing). The tapering design reduces the likelihood of particles getting stuck deep within the filter, as the wider effluent side 20 provides a pathway for debris to exit during cleaning. In addition, the larger effluent-side openings 420 reduce resistance to flow after the fluid passes through the smaller influent-side openings 120. This minimizes the pressure drop across the filter, improving flow efficiency and reducing energy costs in systems like water treatment or industrial filtration.

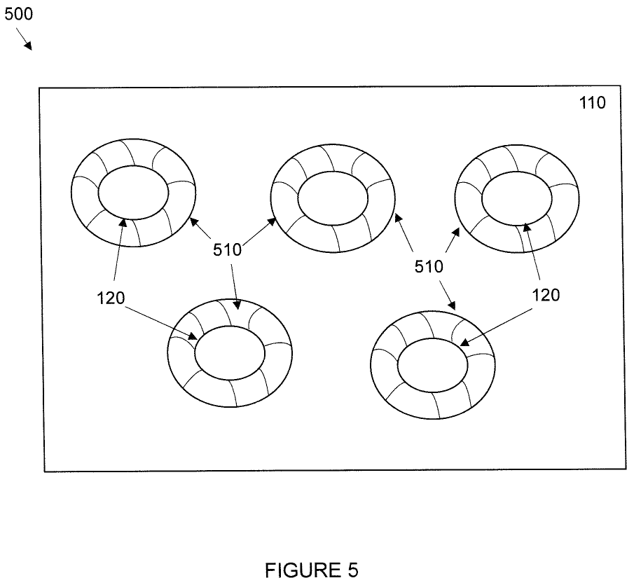

Referring to FIG. 5, illustrated is screen plate 500 an orifice with the inlet edge 510 of the orifice 120 is rounded or sloped. The rounding or sloping of the inlet edge 510 Significantly reduces drag on the fluid. These edges 510 can be on either the influent side or effluent side of a screen. Likewise, when the reliefs are rounded or sloped, there is also a significant decrease drag on the fluid. These ridges and shapes will also assist in lowering the loss coefficient (KL) of the flow through the panel. In other words, a round hole in a flat plate will have a high loss coefficient because the top corner of the hole is perpendicular to the flat face of the plate. The rounded ridges and shapes will lower the loss coefficient because there is a gradual lead into the hole 120. Ultimately the lower loss coefficient will lead to higher flow throughput while maintaining the same headless, or a lower head loss while maintaining the same flow.

As stated previously, the clean side of the panel having very large and tapered holes aid in cleaning the panel by the wash water spray system. With a typical panel with hole corners perpendicular to the plate face, the wash water has a high likelihood to hit the flat face of the panel, leaving this water useless in cleaning and will ricochet back as a mist. Only water that travels through the hole aids in cleaning. The large taper with little to no flat space between holes will guide more wash water through the holes, while increasing water velocity.

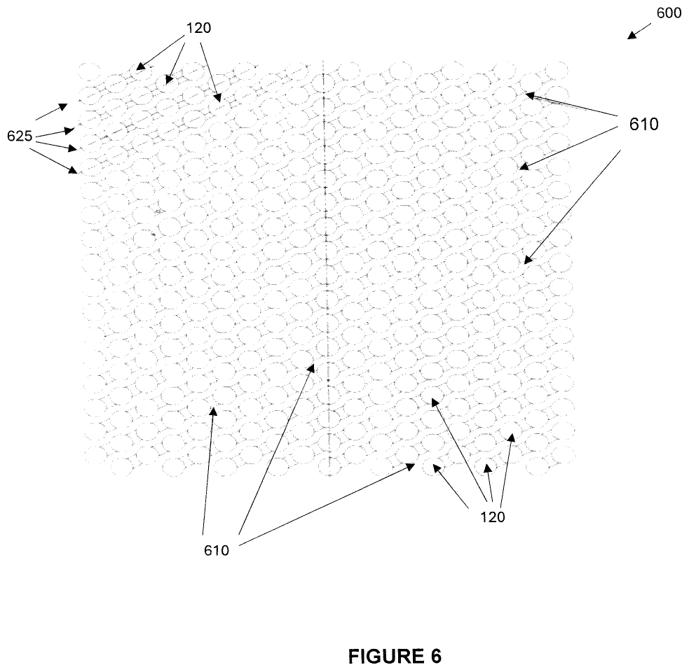

Referring to FIG. 6, illustrated is an increased flow panel 600 with ridges 610 and grooves 625. The inlet side of the panel 600 incorporates ridges or bars 610 and drops in elevation creating channels 625 around the orifices 120. The ridges 610 allow for a layered screening system where there is an initial level of screening that occurs between the intermittent ridges 610 on the panel 600 and then further screening when the water enters the orifice 120 itself.

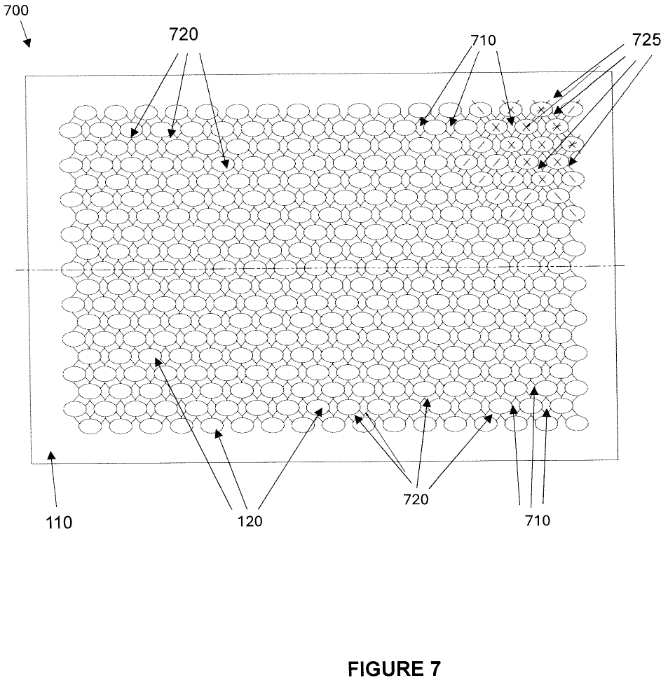

Referring to FIG. 7, illustrated is another embodiment of an increased flow panel 700 with ridges 710 and grooves 720 creating flow channels 725 that enable fluid flow in two different diagonals. Because the ridges 710 are intermittent around the orifices 120, there are open pathways 625 between the ridges and between the orifices 120 to allow numerous flow paths 725 into the orifices 120. Consequently, if debris, such as a candy wrapper, flows onto the screen panel 700 and rests against the screen panel 700, the debris is actually suspended up over the actual orifices on the intermittent ridges 710. Generally speaking, these features that eject debris above the orifice 120 have larger spacing than the orifice size. The features that elevate the debris creates have multiple flow channels rows 725 underneath the ejected debris. The elevating features can also be an ‘accordion’ shape when looking at a cross section of the screening panel 700 where peaks of the accordion will suspend large debris above the holes 120 in the valleys of the accordion. Note that the holes 120 in the valleys of the accordion can be round, triangular, or slots that are perpendicular or parallel to the peaks. The network of pathways 725 between and below the ridges potentially allow water to pass under the debris and into the orifices. Therefore, this screening panel 700 does not get blinded by debris like other screening panels and does not incur the headloss that other screening panels incur. This translates to much better screenings capture, smaller equipment, reduced costs, and simpler operation and maintenance.

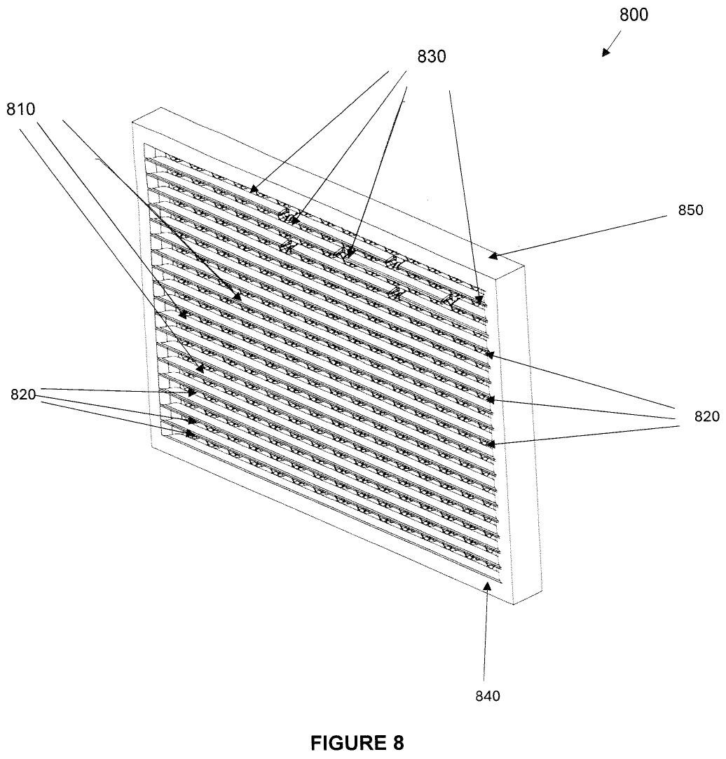

Referring to FIG. 8, illustrated is another embodiment of the panel design 800 with raised bars 810, 830 where each row of holes 820 can be at different elevations from the top surface 840. The rows 820 can be in the vertical or horizontal orientation. These stepped patterns repeat across an entire panel and will act as lifting bars 810, 830 or steps to aid in lifting debris from the main flow while still suspending stiff debris on the outer face 840 of the panel 800 to allow the flow to pass behind and under to available open apertures. The raised bars 810, 830 can be contiguous 810 or non-contiguous 830. The number of steps as well as their depths may change depending on application. The stepped features can also be at different angles to allow for better inlet flow of water to the apertures or holes in the panel. This panel design also decreases the number of perpendicular faces to the water flow on both the front and back side of the panel 800. The step panel configuration allows to have one or numerous steps.

Accordingly, the screen panel 800 has an effluent side and an influent side with the influent face plate with rows of influent holes at different elevations from the influent face plate. The row 820 of influent holes 120 are oriented vertically, diagonally, or horizontally from a top side 850. The rows 820 of influent holes 120 at different elevations create steps that are at differing angles from the influent face plate 840 into the influent holes 120. The rows 820 of influent holes 120 at different elevations create steps that lift debris enabling a flow to pass behind or under the debris to available influent holes in the screen panel 800. An elevated orifice or reliefs reject larger debris, and recessed reliefs or orifices reject smaller debris. Further, effluent side holes on an effluent side plate can have a gradual slope angled into the effluent side holes to reduce drag.

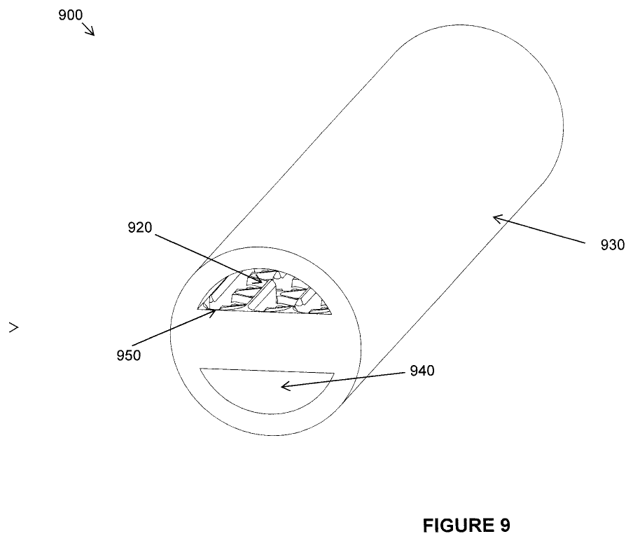

Referring to FIG. 9, illustrated is a screening panel 920 molded within a pipe 930 created as a single unit 900. The panel 920 may be molded as part of different geometric shapes to screen debris within. With water passing through one area of the shape 950, through the panel 920 removing debris, then the cleaned water passes out though the opposed area 940 of the shape. In this situation, water may be reversed to clean the fouled area of the system 900.

Using injection molding as an additive manufacturing process, molten material, usually a thermoplastic (e.g., polypropylene, nylon) or elastomer, is injected under high pressure into mold. Any suitable material may be used. Polypropylene allows for a flexible end product. This pressure ensures the material fills all cavities, capturing fine details of both the filter (e.g., porous or mesh-like structures) and the tube (e.g., hollow cylindrical shape).

These screen panels are typically constructed by using additive manufacturing including three-dimensional printing, injecting molding, or any other process that achieves the desired water flow. Using the additive manufacturing process, the screening panel can even be molded within or attached to another system. Further, the screen panel or parts of the screen panel can be molded into a curved panel or the screen panel is manufactured into various shapes and formed in materials that are flexible.

1. A screen panel comprising an influent side with an influent face plate and an effluent side with an effluent face plate, wherein the influent face plate has reliefs with orifice openings spaced between the reliefs.

2. The screen panel of claim 1, wherein the reliefs comprise ridges or shapes raised above the orifice openings.

3. The screen panel of claim 1, wherein the reliefs comprise grooves or pathways recessed into sidewalls at orifice openings between different orifices, wherein these reliefs allow water to pass between multiple orifices or rows.

4. The screen panel of claim 1, wherein the reliefs allow liquids to pass into the orifice opening when debris is in front of the orifice openings.

5. A screen panel of claim 1, wherein the orifice opening on the influent plate has an influent side gradual slope angled into the orifice opening.

6. A screen panel of claim 1, wherein the orifice openings comprise round holes or other geometrical shapes.

7. A screen panel of claim 1, wherein the depth of orifice openings are greater than the orifice openings area.

8. A screen panel of claim 1, wherein the effluent side has a larger orifice opening that tapers to a smaller orifice opening on the influent side.

9. A screen panel of claim 8, wherein the larger orifice opening on the effluent plate has an effluent side gradual slope angled into the larger orifice opening.

10. A screen panel of claim 1, wherein the screen panel is constructed using additive manufacturing including three dimensional printing.

11. A screen panel of claim 1, wherein the screening panel is molded within or attached to another system.

12. A screen panel of claim 1, wherein an inlet edge of the orifice is rounded or sloped decreasing drag on a fluid.

13. A screen panel of claim 1, wherein the reliefs are rounded or sloped to decrease drag on a fluid.

14. A screen panel of claim 1, wherein the screen panel or parts of the screen panel are molded into a curved panel.

15. The influent face of the panel incorporates shelves or shapes that enhance adhesion and capture of debris.

16. The screen panel of claim 1, wherein multiple orifices or ridges of differing size are incorporated into the same panel.

17. The screen panel of claim 1, wherein the screen panel is manufactured into various shapes and formed in materials that are flexible.

18. A screen panel comprising an effluent side and an influent side with an influent face plate with rows of influent holes at different elevations from the influent face plate.

19. A screen panel of claim 17, wherein the row of influent holes are oriented vertically, diagonally, or horizontally from a top side.

20. A screen panel of claim 17, wherein the rows of influent holes at different elevations create steps that lift debris enabling a flow to pass behind or under the debris to available influent holes in the screen panel.

21. A screen panel of claim 17, wherein the rows of influent holes at different elevations create steps that are at differing angles from the influent face plate into the influent holes.

22. A screen panel of claim 17, wherein effluent side holes on an effluent side plate have a gradual slope angled into the effluent side holes.

23. The screen panel of claim 20, wherein an elevated orifice or reliefs reject larger debris, and recessed reliefs or orifices reject smaller debris.

24. A screen panel of claim 17, wherein the screen panel is constructed using additive manufacturing including three dimensional printing.
